(19) United States
(12) Patent Application Publication
(10) Pub. No.: US 2006/0046006 A1
(43) Pub. Date: Mar. 2, 2006

(54) Multilayer polymeric barrier film, flexible packaging made therewith, and methods

(76) Inventors: Bradley James Bastion, Powder Springs, GA (US); Ronald William Komro, Smyrna, GA (US)

Correspondence Address: SUTHERLAND ASBILL & BRENNAN LLP, 999 PEACHTREE STREET, N.E., ATLANTA, GA, 30309, US

(21) Appl. No.: 10/930,275

(22) Filed: Aug. 31, 2004

(51) Int. Cl. B32B 27/32; B32B 27/08; B32B 27/36; B32B 27/34

(52) U.S. Cl. 428/35.2; 428/35.7; 428/523; 428/483; 428/476.9; 427/248.1; 427/255.6

(57) ABSTRACT

A flexible multilayer polymeric film comprising a flexible base polymer layer, a flexible cyclic olefin copolymer layer which is adhered to the base polymer layer and comprises a cyclic olefin copolymer, and a vapor deposited layer on an exposed surface of the flexible cyclic olefin copolymer layer, the vapor deposited layer comprising at least one barrier coating. Such film is particularly useful to make flexible packaging and the base polymer layer can comprise unoriented polymer in preferred embodiments.

### TECHNICAL FIELD

The present invention relates generally to flexible polymer films with barrier properties and more particularly relates to films including a vapor deposited barrier material. Even more particularly, this invention relates to flexible packaging made with such barrier film.

### BACKGROUND OF THE INVENTION

The food, beverage, and pharmaceutical industries have high demand for packages with characteristic high barrier to gases, water vapor and flavors, while maintaining durability. For this reason, flexible multilayer polymeric film is commonly used in a variety of packages and decorative applications. Although the application field is quite broad, the desired properties of the different films are basically the same. These desired properties include mechanical strength, thermal and chemical resistance, abrasion resistance, moisture barrier, gas barrier (i.e. oxygen), and surface functionality that aids wetting, adhesion, slippage, etc. As a result, a multitude of hybrid films have been developed to service a wide range of applications.

Oxygen barrier of less than 1.00 cc/100 in²/24 hrs (ASTM D3985-95) and moisture barrier properties of less than 0.10 g/100 in²/24 hrs (ASTM F1249-90) are achievable when a vapor deposition is applied to an oriented polypropylene, oriented polyester, or oriented polyamide film. For example, U.S. Pat. No. 5,688,556 discloses a multilayer polymeric film comprising a vapor deposited barrier coating on a layer of ethylene vinyl alcohol copolymer which is adhered to an oriented polymeric substrate. Orientation requires a secondary operation during the film manufacturing process that results in increased costs as compared to film that has not been oriented. The orientation process limits opportunities to achieve optimum heat seal characteristics required for many form/fill/seal packages. These properties include strong seals to insure package integrity under all conditions and/or high hot tack for high speed forming/filling/sealing equipment and/or seal caulking around particulates and folded or wrinkled areas so that there are no capillary leakers resulting in loss of total package barrier. Orientation is desirable to enhance the properties most beneficial for barrier vapor deposition coatings. Benefits of orientation include increased thermal and dimensional stability, increased secant modulus and a smooth micro surface topography favorable to barrier vapor deposition coatings.

Flexible packages are often made of various polymeric films that are coated with polyvinylidene chloride (PVDC). Moisture barrier properties of these films are greater than 0.10 g/100 in²/24 hrs and are not acceptable for critical applications. Flexible packages can also be made from polymeric films that have PVDC incorporated as a coextruded layer. Depending upon PVDC layer thickness, high oxygen and moisture barrier can be achieved. However, the heat sensitivity and corrosive nature of degraded PVDC polymer results in many manufacturing constraints which tend to increase costs. There are also environmental concerns associated with the eventual disposal of PVDC, particularly during any incineration process.

Flexible packages are often made of various polymeric films which incorporate an EVOH (ethylene vinyl alcohol) layer for increased oxygen barrier. These products have moisture barrier greater then 0.10 g/100 in²/24 hrs and oxygen barrier that varies based on moisture content of the EVOH. These films are not acceptable for applications requiring moisture barrier properties of less than 0.10 g/100 in²/24 hrs.

It has also been known to produce a multi-layer container with cyclic olefin copolymer (COC) film which exhibits excellent resistance against the permeation of moisture. For example, Japanese Laid-Open Patent Publication No. 276253/1992 discloses a container for medicines or foods, comprising many layers including two layers of different compositions, at least one of the layers being composed of a thermoplastic norbornene polymer.

Japanese Laid-Open Patent Publication No. 52340/1995 discloses a multi-layer plastic container of a structure in which at least two or more kinds of resin layers are laminated one upon the other, the outer layer being composed of an amorphous resin obtained by the copolymerization of a cyclic olefin with an ethylene, and the inner layer being composed of a polyolefin resin. The layers are adhered together by using an ethylene/α-olefin copolymer modified with an acid.

However, it was found that when a multi-layer container having an intermediate layer of a cyclic olefin copolymer and inner and outer layers of an olefin resin or an ethylene/vinyl alcohol copolymer is filled, the adhesion among the layers is degraded to a conspicuous degree with the lapse of time. That is, the cyclic olefin copolymer and the olefin resin (non-cyclic olefin resin) poorly adhere together, the cyclic olefin copolymer and the ethylene/vinyl alcohol copolymer poorly adhere together, and, hence, an adhesive resin is interposed between the two resin layers as taught in the above-mentioned prior art. Moisture barrier enhancement from the COC is greater then 0.10 g/100 in²/24 hr/mil and not acceptable for critical moisture barrier applications.

Thus, there is a need in the art for a cost effective flexible multilayer polymeric film having barrier properties for use in applications such as but not limited to flexible packaging. Furthermore, there is a particular need in the art for a cost effective un-oriented flexible multilayer polymeric film having barrier properties similar to more costly oriented films with vapor deposited barrier coatings and the better performing seal properties of un-oriented films.

### SUMMARY OF THE INVENTION

Objects and advantages of the invention will be set forth in part in the following description, or may be obvious from the description, or may be learned through practice of the invention. Unless otherwise defined, all technical and scientific terms and abbreviations used herein have the same meaning as commonly understood by one of ordinary skill in the art to which this invention pertains. Although methods and compositions similar or equivalent to those described herein can be used in the practice of the present invention, suitable methods and compositions are described without intending that any such methods and compositions limit the invention herein.

The present invention addresses the above-described need by providing a flexible multilayer polymeric film comprising a flexible base polymer layer, a flexible cyclic olefin copolymer layer which is adhered to the base polymer layer and comprises a cyclic olefin copolymer, and a vapor deposited layer on an exposed surface of the flexible cyclic olefin copolymer layer, the vapor deposited layer comprising at least one barrier coating. In a particular embodiment, the base polymer layer is unoriented so that the multilayer film is economical and has seal performance superior to oriented films with similar vapor deposited barrier coatings. In still another embodiment, a flexible multilayer polymeric film as described above further comprises an overcoat layer on the vapor deposited layer such that the vapor deposited layer is between the cyclic olefin copolymer layer and the overcoat layer.

This invention also encompasses a method for producing a flexible multilayer polymeric film comprising vapor depositing a barrier coating on an exposed surface of a flexible cyclic olefin copolymer layer comprising a cyclic olefin copolymer, wherein said flexible cyclic olefin copolymer layer is adhered to a base polymer layer. Likewise, in a particular embodiment, the base polymer layer is unoriented.

In another embodiment, this invention also encompasses a flexible container useful for packaging material comprising an enclosure formed of the above described flexible multilayer polymeric film which is folded and sealed together so that the material is storable inside the enclosure. In a more particular embodiment, a flexible container is provided comprising a flexible multilayer polymeric film as described above, wherein said flexible base polymer is unoriented. In still another embodiment, a container is provided comprising a flexible multilayer polymeric film as described above, further comprising an overcoat layer on the vapor deposited layer such that the vapor deposited layer is between the cyclic olefin copolymer layer and the overcoat layer.

In yet another embodiment, this invention further encompasses a method for packaging material in a form-fill-seal system comprising feeding the above described flexible multilayer polymeric film through the form-fill-seal system, folding and sealing the multilayer polymeric film in the form-fill-seal system to form a flexible container comprising an enclosure formed of the flexible multilayer polymeric film, depositing the material in the enclosure, and sealing the material in the enclosure. According to still another embodiment, this invention encompasses a packaged material comprising a material stored inside a flexible container, the flexible container comprising an enclosure formed of the above described flexible multilayer polymeric film, which is folded and sealed together for receiving the material inside the enclosure. In a more particular embodiments, the flexible container comprises of the foregoing method and package comprises a flexible multilayer polymeric film wherein the flexible base polymer is unoriented.

Other objects features and advantages of this invention will become apparent from the following detailed description of embodiments, drawings, and claims.

### BRIEF DESCRIPTION OF THE DRAWINGS

FIG. 1a is a perspective view of a flexible container made in accordance with an embodiment of this invention.

FIG. 1b is a partial sectional view of a multilayer film of which the flexible container in FIG. 1a is made.

FIG. 1c is an exploded sectional view illustrating the individual layers of the multilayer film of FIG. 1b.

FIG. 1d is a partial sectional view of a multilayer film made in accordance with another embodiment of this invention in which the vapor deposited barrier layer is laminated with a printed overcoat.

In describing the proffered embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose.

### DETAILED DESCRIPTION OF EMBODIMENTS

Reference now will be made in detail to the presently proffered embodiments of the invention, one or more examples of which are illustrated in the accompanying drawings. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment, can be used on another embodiment to yield a still further embodiment. Thus, it is intended that the present invention cover such modifications and variations within the scope of the appended claims and their equivalents.

As summarized above, this invention encompasses a flexible multilayer polymeric film with a vapor deposited barrier layer on a cyclic olefin copolymer layer which is adhered to a base polymer layer, a method for making such a film, a flexible container comprising such as film, a method for packaging material in a form-fill-seal system using such a flexible container, and packaged material comprising a material stored inside such flexible container. Embodiments of this invention are described below.

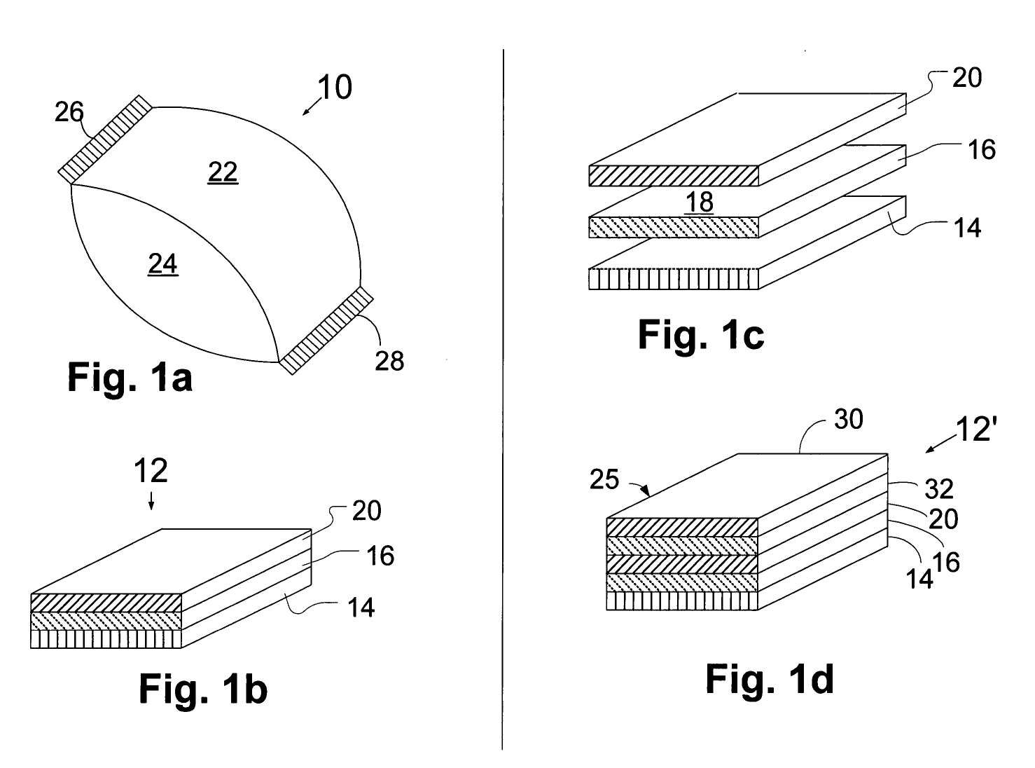

Turning to FIG. 1a, a flexible container 10 made in accordance with an embodiment of this invention is illustrated. It has been discovered that the flexible container of the present invention provides improved barrier performance useful for packaging composition although the film of this invention is useful in other applications in which enhanced barrier is useful.

As used herein, the term “barrier”, and the phrase “barrier layer,” as applied to films and/or film layers, are used with reference to the ability of a film or film layer to serve as a barrier to one or more gases. Barrier may also refer to the ability of a film or film layer to protect, decrease, block or resist the transmission of moisture. Alternatively barrier may be refer the ability of a film or film layer to protect, decrease, block or resist light, including UV, heat, external force or impact, wear, heat resistance, heat aging resistance, chemical, solvent, or abuse. Additionally, barrier may refer to any film or film layer which may protect the stored or packaged material of interest.

The flexible container 10 comprises a flexible multilayer polymeric film 12, as shown in FIGS. 1b, 1c, and 1d, comprising a flexible base polymer layer 14; a flexible cyclic olefin copolymer layer 16 which is adhered to the base polymer layer, the flexible cyclic olefin copolymer layer having an exposed surface 18 and comprising a flexible cyclic olefin copolymer; and a vapor deposited layer 20 on the exposed surface of the cyclic olefin copolymer layer, the vapor deposited layer comprising at least one barrier coating.

As used herein the term “barrier coating” refers to any material with barrier properties. The barrier coating may be organic, e.g. carbon coating; inorganic, e.g. metal, ceramic, oxide coating, or a combination thereof; or a combination of organic and inorganic compounds. Non-limiting examples of barrier coating includes amorphous carbon; oxides of silicon; aluminum; zinc; nickel; tin; iron; copper; chromium; cobalt; silver; gold; magnesium; manganese; lead; or alloy thereof, such as brass, bronze, steel, or the like; plates such as tin plates, galvanized iron; a composite of nickel on aluminum; a composite film of iron on aluminum; a composite of zinc on silver; a composite of zinc on copper; a composite of zinc on aluminum; metal oxides such as aluminum oxide, iron oxide, silver oxide; or a combination thereof.

For example, in accordance with one embodiment of the invention, the flexible container 10 may be pillow shaped as shown in FIG. 1a. The front 22, sides 24, and back of the flexible container may be one continuous multilayer polymeric film 12 (FIG. 1b), or a multilayer polymeric film 12′ laminated to one or more outer plies 25 (FIG. 1d), which is sealed at the top 26 and the bottom 28 of the flexible container with the desired material enclosed or packaged. As will be explained in more detail below, the outer ply 25 shown in FIG. 1d comprises an overcoat 30 laminated to the barrier layer 20 with an adhesive 32 to protect the barrier layer from abrasion or other damage that could impair the barrier performance of the barrier layer. The overcoat layer can be a reverse printed film if desired or can be applied in other ways as described in more detail below.

Although the flexible container 10 in FIG. 1a is pillowed, the flexible container of this invention may be of any shape or size. For example, the flexible container may be square, rectangular, circular, oval, trapezoidal, triangular, pouched, tubular, or pillowed. The flexible container may be of any size suitable for the desired material to be packaged or enclosed. Furthermore, the flexible container 10 may be formed by sealing the film together in any of effective ways known to those skilled in the art. As used herein, the term “seal” refers to any seal of a first region of a film surface to a second region of a film surface, wherein the seal is formed by heating the regions to at least their respective seal initiation temperatures. Suitable seals include, but are not limited to, lap seals, fin seals, butt seals, and the like, and the seals can be made by any of the suitable means known to those skilled in the art such as heating sealing or the application of cold or hot melt adhesives, a heated bar, hot air, hot wire, infrared radiation, ultrasonic sealing, radio frequency sealing, laser sealing, and the like.

The flexible base polymer layer 14 may be any polymeric substrate known in the arts which is bondable to the flexible cyclic olefin copolymer layer 16 either directly or with a tie layer in between. For example, the base polymer layer 14 may include, but is not limited to, polypropylene, polyethylene, polyester, polystyrene, polyamide, EVOH, polyurethane, copolymers thereof, and blends thereof. It is anticipated that the flexible base polymer layer 14 may be a single layer or multiple layers of a single polymer or blends of multiple polymers. It is understood in the art that the term “multiple” means more than one. For example, the flexible base polymer layer 14 may be a single layer of polyethylene. In another example, the flexible base polymer layer 14 may be a blend of one or more polymer resulting in a single layer or multiple layers.

In one particular embodiment of the present invention, the flexible base polymer layer 14 is an unoriented cast or blown polymer layer. As used herein, the term “oriented” refers to a realignment of molecules in a definite pattern by application of an external force greater then the tensile yield force to a film in the solid phase to modify characteristics of the original structure. The term “unoriented,” on the other hand, refers to polymer films with external force deformations in the melt phase only.

Without being bound by theory, oriented base polymers and surface layers, which are more expensive and more time consuming to produce than unoriented base polymers, provide the high levels of surface smoothness and dimensional stability required for achieving barrier properties after vapor depositing the barrier layer. Surprisingly, it has been discovered that the present invention provides a flexible multilayer polymeric film and a method for packaging material in a flexible container made out of the multilayer polymeric film comprising an unoriented flexible base polymer layer, a COC layer, and a vapor deposited barrier layer. The COC layer functions in part to provide the required surface and unoriented film modulus and dimensional stability to produce high barrier vapor deposition coating. This embodiment provides a multilayer film with barrier comparable to that of vapor deposition coated oriented polymer, but with less expensive unoriented polymer which can be melt extruded.

It is contemplated that the polymer or polymers comprising the flexible base polymer may be selected with a density value ranging from about 0.700 to about 1.500. Another example for the density value may range from about 0.800 to about 1.100. In yet another example, the density value of the polymer may be from about 0.89 to about 0.965. When practicing the present invention, one of ordinary skill in the art could easily ascertain the density of the polymer or polymers comprising the flexible base polymer from a wide variety of sources such as the CRC Handbook of Chemistry and Physics, 84^{th} Ed., CRC Press, Inc, 2003-2004 or any other source available.

The flexible cyclic olefin copolymer layer 16 of the present invention comprises at least one cyclic olefin copolymer. As used herein, the phrase “cyclic olefin copolymer” (COC) refers to copolymers made by the polymerization of at least one α-olefin comonomer with at least one cyclic aliphatic comonomer (and/or at least one cyclic aromatic comonomer) having a reactive olefin portion thereof (i.e., forming a portion of the cyclic structure) or a reactive olefin portion thereon (e.g., an α-olefin substituent on the cyclic structure). Preferred α-olefin comonomers include C₂-C₂₀ α-olefin, especially C₂-C₁₀ aliphatic α-olefin comonomers, and preferably one or more of C₂, C₄, C₆, and/or C₈ α-olefin comonomer. Norbornene is a preferred cyclic olefin comonomer. Ethylene/norbornene copolymer is an especially preferred cyclic olefin copolymer for use in the film of the present invention.

As used herein, the term “copolymer” refers to polymers formed by the polymerization reaction of at least two different monomers. For example, the term “copolymer” includes the copolymerization reaction product of ethylene and an α-olefin. The term “copolymer” is also inclusive of, for example, the copolymerization of a mixture of ethylene or propylene. As used herein, the term “copolymerization” refers to the simultaneous polymerization of two or more monomers. The term “copolymer” is also inclusive of random copolymers, block copolymers, and graft copolymers.

The flexible cyclic olefin copolymer layer 16 may be entirely of cyclic olefin copolymer of only one species such as ethylene/norbornene copolymer. Alternatively, the flexible cyclic olefin copolymer layer 16 may also comprise entirely of cyclic olefin copolymers of various cyclic olefin copolymers species. The flexible cyclic olefin copolymer layer 16 may also comprise a blend of least one cyclic olefin copolymer and at least one polymer other than a cyclic olefin copolymer. For example, the flexible cyclic olefin copolymer layer 16 may comprise ethylene/norbornene copolymer and polyethylene. For example, the cyclic olefin copolymer is desirably present in the cyclic olefin copolymer layer in an amount greater than 40% by weight of the cyclic olefin copolymer layer, more preferably in an amount greater than 60% by weight of the cyclic olefin copolymer layer, even more preferably in an amount greater than 80% by weight of the cyclic olefin copolymer layer, and still more preferably in an amount greater than 90% by weight of the cyclic olefin copolymer layer. More particularly, in preferred embodiments, the COC layer may comprise a blend of COC to other polymers in a weight ratio of from about 40:60 percent to about 100:0 percent, more preferably in a weight ratio of from about 60:40 percent to about 95:5 percent, even more preferably in a weight ratio of from about 80:20 percent to about 95:5 percent, and still more preferably in a weight ratio of from about 90:10 percent to about 95:5 percent. It is appreciated that one skilled in the art could easily arrive at all the permutations for the flexible cyclic olefin copolymer layer 16 provided that it is compatible with the flexible base polymer layer 14.

In preferred embodiments, it is contemplated that a layer weight ratio of the COC layer to the flexible base polymer may be for example from about 5:95 percent to about 95:5 percent, more preferably from about 5:95 percent to about 40:60 percent, and even more preferably from about 5:95 percent to about 15:85 percent.

Any process melt temperature may be used provided that the temperature does not adversely affect the performance of the COC layer or the flexible base polymer layer. For example, the process melt temperature may range from about 150° C. to about 280° C. A further example of the process melt temperature is from about 180° C. to about 240° C.

It is appreciated that a skilled artisan may utilize COCs of any glass transition temperature with the range of process melt temperature. The glass transition temperature range for COC may be for example from about 60° C. to about 160° C. A further example of the COC glass transition range may be from about 70° C. to about 140° C. By way of example, a process melt temperature of about 180° C. may be used for blends comprising the flexible base polymer and COC having a transition glass temperature of about 80° C. In another example, a process melt temperature of about 240° C. may be used for blends comprising the flexible base polymer and COC having a transition glass temperature of about 136° C. It is appreciated that a skilled artisan would be able to optimize the process melt temperature when utilizing the desired flexible base polymer and COC as taught.

The flexible base polymer layer and the COC layer may also contain one or more additives provided said additives do not interfere with performance of the composite. Suitable additives include, but are not limited to, cling additives and tackifiers (e.g., PIB), slip (e.g. erucamide, stearamide, oleamide, behenamide) and antiblock agents (e.g. silica, talc, diatomaceous earth), antioxidants (e.g., hindered phenolics such as Irganox.RTM. 1010 or Irganox.RTM. 1076 supplied by Ciba Geigy), phosphites (e.g., Irgafos.RTM. 168 also supplied by Ciba Geigy), Standostab PEPQ.TM. (supplied by Sandoz), pigment, colorant or dye, light stabilizer, reinforcement filler and fiber, carbon black, stabilizer, plasticizer, antistatic agent, ultraviolet light absorber, antioxidant, lubricant, processing aid and the like. Although not required to achieve the desired results of this invention, the optional additives should be incorporated in such a manner or to the extent that they do not interfere with the substantial barrier properties or be detrimental in any way to the object of the present invention.

The COC layer and the flexible base polymer layer thickness is of suitable thickness if it is capable of being formed into a continuous layer which will have the necessary strength to survive conditions normal to its intended use. The thickness of the layers is beneficially in the range from about 0.5 to about 100 micrometers, and preferably from about 1.0 to about 25 micrometers.

In one embodiment of the present invention, the flexible multilayer polymeric film is provided comprising a coefficient of friction (C.O.F.) value of, for example, from about 0.1 to about 0.6. A further example of the C.O.F. value is from about 0.2 to about 0.4.

In one embodiment, the methods and compositions of the present invention provide a smooth surface of flexible cyclic olefin copolymer layer on which to apply vacuum deposited barrier coating. Characteristic of this embodiment results in a flexible multilayer polymeric film with a robust and durable barrier performance when the film is creased, flexed, folded, and crushed as is routinely experienced in forming, filling, sealing, and distributing packages of environmentally-sensitive material.

In accordance with the present invention, any material that can be vapor deposited and offer barrier properties can be utilized as the vapor deposited layer 20. The vapor deposited layer 20 can be any barrier coating, for example, an organic coating, such as a carbon coating, or an inorganic coating, such as metal, ceramic, oxide coating, or a combination thereof. A preferred carbon coating is amorphous carbon, which is due in part to its barrier characteristics and ease of application. Non-limiting examples of oxide coatings include oxides of silicon (SiOₓ, in which 1≦x≦2) and of aluminum (Al₂O₃). Moreover, mixtures of various coatings can also be utilized, e.g., SiOₓ, in which 1≦x≦2, and Al₂O₃. Ceramic as used in the present invention may be any material with silicon or carbon components.

Any vapor deposition technique can be utilized in accordance with the present invention, provided that the reaction chamber temperatures are not detrimental to the substrate being coated. Non-limiting examples of vapor depositing techniques include chemical vapor deposition (CVD) (e.g. glow discharge and Plasma Enhanced Chemical Vapor Deposition (PECVD)) and physical vapor deposition (PVD) (e.g. ion beam sputtering and thermal evaporation). In one embodiment, PECVD is used because the reaction chamber temperatures are usually well below the melting points of the contemplated polymeric materials to be utilized as the substrate. This is due in part due to the low temperature plasma that is formed during the PECVD coating process.

PVD techniques usually require reaction chamber temperatures above the melting points of the contemplated polymeric substrates. However, if the reaction chamber temperatures can be kept at a temperature that is not detrimental to the polymeric substrate, the PVD technique can be utilized in accordance with the present invention.

As will be apparent to those skilled in the art, the source material for the vapor depositing layer is dependent on the type of vapor deposition process utilized. For example, in PVD processes, the source material is usually the same chemical specie that is being deposited as the barrier coating. For example, a solid SiOₓ source is placed within reaction chamber to be vaporized and is thereafter deposited as a SiOₓ coating on the substrate.

In CVD processes, the source material is not the same chemical specie that is being deposited as the coating. For example, gaseous reactants such as hexamethyldisiloxane (HMDSO) and oxygen (O₂) are placed in the reaction chamber to react and thereafter provide a SiOₓ coating on the substrate. Thus, the main gaseous reactant, e.g., HMDSO, decomposes to form the desired coating on the substrate.

Because CVD coating processes are preferred, the source material for the barrier coating is preferably a gaseous reactant or a mixture of gaseous reactants. Alternatively, non-gaseous source materials can be utilized provided that they can be transformed to a gaseous state, e.g., vaporized or sublimed.

The deposition of an amorphous carbon coating requires a carbon source as the gaseous reactant. Preferably, the gaseous reactant is a hydrocarbon having from about 1 to 20 carbon atoms. For example, acetylene gaseous reactant may be utilized.

Similarly, the deposition of a SiOₓ coating, in which 1≦x≦2, requires a silicon-containing compound and an oxidizing agent as the gaseous reactants. Examples of these silicon-containing compounds include, but are not limited to, silanes, siloxanes and silanols. For example, hexamethydisiloxane and tetraethoxylsilane (TEOS) may be used as gaseous reactants. Oxidizing agents include, but are not limited, molecular oxygen (O₂) and nitrous oxide (N₂O). However, other sources for atomic oxygen can be readily utilized. For example, the deposition of an aluminum oxide coating requires an aluminum-containing compound and an oxidizing agent. An example of an aluminum-containing compound is aluminum chloride (AlCl₃). The oxidizing agents can be the same as previously described for the deposition of an SiOₓ coating.

Overall, once a particular vapor depositing layer has been selected, one of ordinary skill in the art can easily be ascertain the gaseous reactants required to vapor deposit the barrier coating.

Upon the introduction of the gaseous reactant to the reaction chamber, the main gaseous reactant decomposes or reacts with other gaseous reactants and is thereafter deposited on the exposed high energy surface as a barrier coating. This coating may range in thickness for example from about 10 to about 5000 angstroms. A further example includes a coating thickness from about 100 to about 2000 angstroms. The thickness of the coating will be primarily dependent on the amount of time allowed for deposition.

The plasma utilized with the present invention is preferably generated by the application of a primary radio frequency to a first electrode. This radio frequency excites the gas mixture flowing through the chamber, thereby forming a plasma. This gas mixture is preferably a mixture of the gaseous reactants mentioned above, e.g., acetylene or TEOS and oxygen, and an inert or noble gas such as argon or helium.

Apparatuses adapted for vapor deposition, and more specifically PECVD, are well known and commercially available. Such apparatuses generally include a chamber sized for receipt of a substrate. The apparatus additionally includes a vacuum pump for evacuating the chamber, means for introducing a gas mixture to the chamber under controlled conditions, and means for generating a plasma within the chamber.

In one particularly preferred embodiment, the plasma generation means includes distally spaced first and second electrodes, which together can be employed to introduce independent dual energy sources into the reaction chamber. A primary radio frequency of about 13.56 MHZ is applied to the first electrode and a secondary radio frequency of about between 90 KHz to 450 KHz is applied to the second electrode. Preferably, the chamber serves as the ground for both radio frequencies.

The primary frequency generates the plasma (by exciting the gas mixture), while the secondary frequency is believed to facilitate the deposition of the carbon on the high energy surface by exciting the molecules of the coating material being deposited. This rationale is supported by the fact that a visible change in the plasma is observed upon application of this second radio frequency.

Other means of generating the plasma are also contemplated. For example, a primary frequency in the microwave range, e.g., about 2.45 GHz, can also be utilized. In addition, photometric means such as lasers can be employed to excite the gas mixture. Magnets can also be utilized to aid in directing the coating material to the substrate.

The chamber also includes a substrate holder plate for supporting the polymeric substrate to be coated. This substrate holder plate is preferably integral with the second electrode. In addition, the substrate holder plate may include either a flat or an arcuate support surface. It is contemplated that the use of an arcuate support surface would facilitate commercial production of the present invention.

The flexible multilayer polymeric film may be made according any known method. For example, the flexible multilayer polymeric film of the present invention can be obtained by a process comprising melt kneading the components by means of a known kneading apparatus such as an extruder or Banbury mixer, a process comprising dissolving the components in a common solvent and then evaporating the solvent, or a process comprising adding a solution of the components to a poor solvent to perform precipitation. Additionally, the flexible multilayer polymeric film of the present invention may be constructed from two or more film layers by any film lamination and/or coextrusion technique. Non-limiting examples of a melt-extrusion method include T-die method and inflation method.

Suitable blown film processes are described, for example, in The Encyclopedia of Chemical Technology, Kirk-Othmer, Third Edition, John Wiley & Sons, New York, 1981, Vol. 16, pp. 416-417 and Vol. 18, pp. 191-192. A suitable cast extrusion method is described, for example, in Modern Plastics Mid-October 1989 Encyclopedia Issue, Volume 66, Number 11, pages 256 to 257. Suitable coextrusion techniques and requirements are described by Tom I. Butler in Film Extrusion Manual: Process, Materials, Properties, “Coextrusion”, Ch. 4, pp. 31-80, TAPPI Press, (Atlanta, Ga. 1992).

The overcoat 30 is adhered to the barrier layer 20 to protect the barrier layer and is deposited over the barrier layer. Any suitable material may be used. Preferably, the overcoat 30 is a polymer film such as oriented polypropylene film or polyester film or the like. Such films may be applied by lamination. Alternatively, the overcoat 30 can be a polymer coating such as a varnish applied directly to the barrier layer 20.

As shown in FIG. 1a, the flexible container 10, useful for packaging a variety of materials comprises an enclosure formed of the flexible multilayer polymeric film 12, which is folded and sealed together so that the composition is storable inside the enclosure. The flexible container of this invention made in accordance with various embodiments may be used to package any material (packaging material) which may require barrier characteristics. For example, the packaging material can be used for packaging any materials such as drugs, foods, beverages, electronics, daily necessaries and miscellaneous goods. In particular, because of its excellent moisture and oxygen barrier, high opacity and impact resistance, the molded product can favorably be used for packaging particularly solid medicines such as tablet, capsule and powder medicines, liquid medicines, foods such as rice cracker, snacks and cookies, meat, cereal, condiment packages, such as ketchup, mayonnaise, mustard, cocktail sauce, tarter sauce, honey, or the like, chips, dried fruits, hygroscopic materials such as cigarette and tea, beverages, electronic products, such as microchips, processors, and the like. Further examples of packages include bags, packs, PTP's (press through packs), twist-wrapping film, wrapping film, easy-peel film, containers made up of molded sheets, such as tetra pack and milk pack, medical containers, such as medicine bottles, vials, liquid-transportation bottles and syringe dyalyzers (e.g., prefilled syringes), physical and chemical appliances, such as laboratory dishes, test tubes and analytical cells, and cosmetic bottles.

The material to be packaged or stored may be accomplished according to any known means in the art such as a standard “Form, Fill and Seal” (f/f/s) machine.

Thus, in another embodiment, a method for packaging composition in a form-fill-seal system is provided comprising feeding the flexible multilayer polymeric film 12 through the form-fill-seal system; folding and sealing the multilayer polymeric film in the form-fill-seal system to form a flexible container 10 comprising an enclosure formed of the flexible multilayer polymeric film 12; depositing the composition in the enclosure; and sealing the composition in the enclosure.

However, it is not necessary that the filling step and sealing step be performed at the same time as the forming operation. This procedure may be performed according to methods known to those of skill in the art, such that as disclosed in U.S. Pat. No. 5,135,464, col. 8, ll. 6-19.

In a standard horizontal f/f/s machine, a sheet of flexible sheet material such as the flexible multilayer polymeric film 12 from a roll is fed to a plow assembly which folds the sheet in half. A plurality of closures are formed in the flexible sheet material wherein the closures are spaced apart and are perpendicular to the fold. The folded edge may function as the closure at the bottom edge of the enclosure, or if desired, a seam may be formed along the folded edge. The flexible sheet material is cut to form a plurality of enclosures comprising at least two layers, an open top edge, two sealed side edges and a bottom folded or sealed edge. The enclosure is filled and then a closure is formed on the flexible sheet material.

In a standard vertical f/f/s machine, flexible sheet material such as the flexible multilayer polymeric film 12 from a roll is fed through a series of rollers. A bag-forming collar receives the sheet from the rollers and changes the sheet travel from a flat plane and shapes it around a bag forming tube. As the flexible sheet material moves down around the tube, the overlapped edges of the sheet are sealed with a vertical seal bar, thereby forming the flexible sheet material into a tube. The length of the flexible container will be equal to the extent of the flexible sheet material hanging down from the bottom of the tube. A filling tube is used to fill the container. A cross seal consisting of a front and rear cross-sealing jaw seals the container. Each cross sealing jaw comprises a top sealing section and a bottom sealing section with a container cutoff device in between. The top sealing section seals the bottom of an empty container suspended down from the forming tube, and the bottom portion seals the top of a filled container. The cutoff device, which can be a knife or a hot wire, operates during the jaw closing/sealing operation. Thus, when the jaws open, the filled container is released from the machine. Representative seals 26 and 28 are shown in FIG. 1a.

### EXAMPLE

The film type was prepared in accordance to an embodiment of the present invention and the blends for each sample are shown in Table 1. The information under blends includes the amount of each layer in percent by weight of the laminate and the amounts in percent by weight of each component in each layer. The available MVTR and OTR from each of the samples for the base, metallized, laminate, former, stressed former and 500 gelbo flex cycle testing are shown in Table 2. The results from Table 2 are analyzed from samples A-W with unoriented base polymers while “Oriented 1-3” samples are used as control, which are oriented and commercially available.

The apparatus used for the extrusion lines were an 8 layer blown film line with two 4.5″ extruders, two 3.5″ extruders, one 2.5″ extruder and 3 2″ extruders and a 5 extruder cast film line using a 7 layer feedblock to feed the single manifold slot die. The blown film extrusion line used a stacked film die. The extrusion temperature range was from 160-260° C. and the casting roll temperature was 35° C. The die gap was 750 microns and the film thickness was 30 microns.

Table 2 chart headings refer to “base” as the base film prior to the process of depositing a barrier vapor deposition layer on the surface. The “metallized” heading refers to the same base film noted in the same “row” of data after the barrier (i.e. Metal) coating has been applied. The laminated column refers to these same metallized base films that are laminated to a reverse printed Biaxally oriented Polypropylene. The “former” heading refers to a laminated BOPP/adh/metalized sealant film measured after this film has been run over a forming collar to form a pillow pouch bag. The creasing of the structure that occurs has a detrimental affect on brittle barrier layers by creating fractures. The “stressed former” heading refers to a laminated BOPP/adh/metalized sealant film measured after this film has been run through a form, fill and seal machine and over a former collar. This is similar to the “former” test with the exception that several idler rollers are stopped from turning and a high amount of brake tension is applied to the film. This insures that any creases are severely pressed into the film.

Furthermore, the machine is “short cycled” in a manner that wrinkles the film prior to making the end seals of the pillow pouch. This represents very adverse conditions as compared to a normally maintained and operated form fill and seal machine. The “gelbo 500” heading refers to a laminated BOPP/PE/metalized sealant film measured after this film has been cycled through 500 gelbo flex cycles. The gelbo flex cycle is described by ASTM (American Society for Testing and Materials) procedure F392-93 (Standard Test Method for Flex Durability of Flexible Barrier Materials).

The barrier properties were measured per ASTM (American Society for Testing and Materials) procedure F1249-90 (Water Vapor Transmission Rate Through Plastic Films and sheeting using modulated infrared sensor) and procedure D3985-95 (Oxygen Gas Transmission Rate Through Plastic Film and Sheeting and using Coulometeric Sensor)

Sample “A” referenced in Tables 1 & 2 attached is a control sample with COC as a buried versus exposed layer.

TABLE 1

| Sample | Blend |
|---|---|
| A | 10% [100-Soarnol DC3203F (EVOH)] |
| (com- | 8% [80:20-NA334 (LDPE):Bynel 41E710 (Tie Conc.)] |
| par- | 25% [80:20-Dow D118 (HPP):Polycom D55107 (White)] |
| ative) | 6% [80:20-NA334 (LDPE):Bynel 41E710 (Tie Conc.)] |
| | 5% [0:100-Ticona-Topas 8007 (COC):NA334 (LDPE)] |
| | 6% [80:20-NA334 (LDPE):Bynel 41E710 (Tie Conc.)] |
| | 25% [80:20-Dow D118 (HPP):Polycom D55107 (White)] |
| | 15% [80:20-EX.-ECD3512CB (LLDPE):Amp.10063 (AB)] |
| B | 10% [90:10-Ticona-Topas 8007 (COC):NA334 (LDPE)] |
| | 8% [80:20-NA334 (LDPE):Bynel 41E710 (Tie Conc.)] |
| | 25% [80:20-Dow D118 (HPP):Polycom D55107 (White)] |
| | 6% [80:20-NA334 (LDPE):Bynel 41E710 (Tie Conc.)] |
| | 5% [100-Soarnol DC3203F (EVOH)] |
| | 6% [80:20-NA334 (LDPE):Bynel 41E710 (Tie Conc.)] |
| | 25% [80:20-Dow D118 (HPP):Polycom D55107 (White)] |
| | 15% [80:20-Exxon-ECD3512CB (LLDPE):Polyfil ABC-5000PB |
| | (Talc-AB)] |
| C | 10% [87:13-Ticona-Topas 8007 (COC):Equistar NA951 |
| | (LDPE)] |
| | 10% [100-CPChem D350 (mLMDPE)] |
| | 23% [70:30-Equistar (HDPE):S.P.D55085 TiO₂)] |
| | 5% [100-Plexar 3227 (Tie Layer)] |
| | 9% [100-Soarnol DC3203F (EVOH)] |
| | 5% [100-Plexar 3227 (Tie Layer)] |
| | 23% [100-Equistar L5885 HDPE)] |
| | 15% [92:8-CPChem D143 (LLDPE):ABC2000CAB (AB)] |
| D | 10% [95:5-Ticona-Topas 8007 (COC):NA334 (LDPE)] |
| | 8% [80:20-NA334 (LDPE):Bynel 41E710 (Tie Conc.)] |
| | 23% [100-Dow D118 (HPP)] |
| | 6% [80:20-NA334 (LDPE):Bynel 41E710 (Tie Conc.)] |
| | 9% [100-Soarnol DC3203F (EVOH)] |
| | 6% [80:20-NA334 (LDPE):Bynel 41E710 (Tie Conc.)] |
| | 23% [100-Dow D118 (HPP)] |
| | 15% [80:20-Chevron 4517 (LDPE):Polyfil ABC-5000PB (Talc- |
| | AB)] |
| E | 10% [95:5-Ticona-Topas 8007 (COC):NA334 (LDPE)] |
| | 8% [80:20-NA334 (LDPE):Bynel 41E710 (Tie Conc.)] |
| | 23% [100-Dow D118 (HPP)] |
| | 6% [80:20-NA334 (LDPE):Bynel 41E710 (Tie Conc.)] |
| | 9% [100-Soarnol DC3203F (EVOH)] |
| | 6% [80:20-NA334 (LDPE):Bynel 41E710 (Tie Conc.)] |
| | 23% [100-Dow D118 (HPP)] |
| | 15% [80:20-Exxon-3512CB (LLDPE):Polyfil ABC- |
| | 5000PB (Tale-AB)] |
| F | 10% [95:5-Ticona-Topas 8007 (COC):NA334 (LDPE)] |
| | 8% [80:20-NA334 (LDPE):Bynel 41E710 (Tie Conc.)] |
| | 23% [100-Dow D118 (HPP)] |
| | 6% [80:20-NA334 (LDPE):Bynel 41E710 (Tie Conc.)] |
| | 9% [100-Soarnol DC3203F (EVOH)] |
| | 6% [80:20-NA334 (LDPE):Bynel 41E710 (Tie Conc.)] |
| | 23% [100-Dow D118 (HPP)] |
| | 15% [97:3-Exxon-3512CB (LLDPE):Ampacet 101501 (Slip)] |
| G | 10% [95:5-Ticona-Topas 8007 (COC):NA334 (LDPE)] |
| | 7% [80:20-NA334 (LDPE):Bynel 41E710 (Tie Conc.)] |
| | 17% [100-Dow D118 (HPP)] |
| | 5% [80:20-NA334 (LDPE):Bynel 41E710 (Tie Conc.)] |
| | 9% [100-Soarnol DC3203F (EVOH)] |
| | 5% [80:20-NA334 (LDPE):Bynel 41E710 (Tie Conc.)] |
| | 17% [100-Dow D118 (HPP)] |
| | 30% [40:20:40-Exxon 3139 (LLDPE):Polyfil ABC-5000PB |
| | (Talc-AB):Exxon 3512 CB (LLDPE)] |
| H | 10% [95:5-Ticona-Topas 8007 (COC):NA334 (LDPE)] |
| | 8% [80:20-NA334 (LDPE):Bynel 41E710 (Tie Conc.)] |
| | 23% [100-Dow D118 (HPP)] |
| | 6% [80:20-NA334 (LDPE):Bynel 41E710 (Tie Conc.)] |
| | 9% [100-Soarnol DC3203F (EVOH)] |
| | 6% [80:20-NA334 (LDPE):Bynel 41E710 (Tie Conc..)] |
| | 23% [100-Dow D118 (HPP)] |
| | 15% [80:20-Basell 5C30F (RCPP):Polyfil ABC-5000PB)] |
| I | 10% [95:5-Ticona-Topas 8007 (COC):NA334 (LDPE)] |
| | 8% [80:20-NA334 (LDPE):Bynel 41E710 (Tie Conc.)] |
| | 23% [100-Dow D118 (HPP)] |
| | 6% [80:20-NA334 (LDPE):Bynel 41E710 (Tie Conc.)] |
| | 9% [100-Soarnol DC3203F (EVOH)] |
| | 6% [80:20-NA334 (LDPE):Bynel 41E710 (Tie Conc.)] |
| | 23% [100-Dow D118 (HPP)] |
| | 15% [100-Dow D118 (HPP)] |
| J | 10% [95:5-Ticona-Topas 8007 (COC):NA334 (LDPE)] |
| | 8% [80:20-NA334 (LDPE):Bynel 41E710 (Tie Conc.)] |
| | 23% [100-Dow D118 (HPP)] |
| | 6% [80:20-NA334 (LDPE):Bynel 41E710 (Tie Conc.)] |
| | 9% [100-Soarnol DC3203F (EVOH)] |
| | 6% [80:20-NA334 (LDPE):Bynel 41E710 (Tie Conc.)] |
| | 23% [100-Dow D118 (HPP)] |
| | 15% [100-Dow D118 (HPP)] |
| K | 10% [85:15-Ticona-Topas 8007 (COC):Chevron 4517 (LDPE)] |
| | 44% [100-Chevron 9607XD (HDPE)] |
| | 8% [100-Dupont 2174 (Tie)] |
| | 10% [100-Chevron 9607XD (HDPE)] |
| | 8% [100-Dupont 2174 (Tie)] |
| | 20% [80:20-Chevron 4517 (LDPE):Polyfil ABC-5000PB (Talc- |
| | AB)] |
| L | 10% [85:15-Ticona-Topas 8007 (COC):Chevron 4517 (LDPE)] |
| | 44% [80:20-Chevron 9607XD (HDPE):Ticona-Topas 8007 |
| | (COC)] |
| | 8% [100-Dupont 2174 (Tie)] |
| | 10% [100-Chevron 9607XD (HDPE)] |
| | 8% [100-Dupont 2174 (Tie)] |
| | 20% [80:20-Chevron 4517 (LDPE):Polyfil ABC-5000PB (Talc- |
| | AB)] |
| M | 10% [80:20-Ticona-Topas 8007 (COC):Soarnol DC3203F |
| | (EVOH)] |
| | 44% [85:15-Dow D118 (HCPP):Chevron 4517 (LDPE)] |
| | 8% [100-Dupont 2174 (Tie)] |
| | 10% [100-Chevron 9607XD (HDPE)] |
| | 8% [100-Dupont 2174 (Tie)] |
| | 20% [80:20-Chevron 4517 (LDPE):Polyfil ABC-5000PB (Talc- |
| | AB)] |
| N | 10% [20:80-Ticona-Topas 8007 (COC):Chevron 4517 (LDPE)] |
| | 44% [85:15-Dow D118 (HCPP):Chevron 4517 (LDPE)] |
| | 8% [100-Dupont 2174 (Tie)] |
| | 10% [100-Chevron 9607XD (HDPE)] |
| | 8% [100-Dupont 2174 (Tie)] |
| | 20% [80:20-Chevron 4517 (LDPE):Polyfil ABC-5000PB (Talc- |
| | AB)] |
| O | 10% [40:60-Ticona-Topas 8007 (COC):Chevron 4517 (LDPE)] |
| | 44% [85:15-Dow D118 (HCPP):Chevron 4517 (LDPE)] |
| | 8% [100-Dupont 2174 (Tie)] |
| | 10% [100-Chevron 9607XD (HDPE)] |
| | 8% [100-Dupont 2174 (Tie)] |
| | 20% [80:20-Chevron 4517 (LDPE):Polyfil ABC-5000PB (Talc- |
| | AB)] |
| P | 10% [70:30-Ticona-Topas 8007 (COC):Chevron 4517 (LDPE)] |
| | 44% [70:30-Dow D118 (HCPP):Chevron 4517 (LDPE)] |
| | 8% [100-Dupont 2174 (Tie)] |
| | 10% [100-Chevron 9607XD (HDPE)] |
| | 8% [100-Dupont 2174 (Tie)] |
| | 20% [80:20-Chevron 4517 (LDPE):Polyfil ABC-5000PB (Talc- |
| | AB)] |
| Q | 10% [70:30-Ticona-Topas 8007 (COC):Chevron 4517 (LDPE)] |
| | 44% [85:15-Dow D118 (HCPP):Chevron 4517 (LDPE)] |
| | 8% [100-Dupont 2174 (Tie)] |
| | 10% [100-Chevron 9607XD (HDPE)] |
| | 8% [100-Dupont 2174 (Tie)] |
| | 20% [80:20-Chevron 4517 (LDPE):Polyfil ABC-5000PB (Talc- |
| | AB)] |
| R | 10% [85:15-Ticona-Topas 8007 (COC):Chevron 4517 (LDPE)] |
| | 44% [85:15-Dow D118 (HCPP):Chevron 4517 (LDPE)] |
| | 8% [100-Dupont 2174 (Tie)] |
| | 10% [100-Chevron 9607XD (HDPE)] |
| | 8% [100-Dupont 2174 (Tie)] |
| | 20% [80:20-Chevron 4517 (LDPE):Polyfil ABC-5000PB (Talc- |
| | AB)] |
| S | 6% [85:15-Ticona-Topas 8007 (COC):Chevron 4517 (LDPE)] |
| | 74% [100-Chevron 9607XD (HDPE)] |
| | 20% [50:30:20-Chevron 4517 (LDPE):Exxon 3512CB |
| | (LLDPE):Polyfil ABC-5000PB (Talc AB)] |
| T | 6% [85:15-Ticona-Topas 8007 (COC):Chevron 4517 (LDPE)] |
| | 74% [100-Chevron 9607XD (HDPE)] |
| | 20% [50:30:20-Chevron 4517 (LDPE):Exxon 3512CB |
| | (LLDPE):Polyfil ABC-5000PB (Talc AB)] |
| U | 6% [85:15-Ticona-Topas 8007 (COC):Chevron 4517 (LDPE)] |
| | 74% [85:15-Dow D118 (HCPP):Chevron 4517 (LDPE)] |
| | 20% [50:30:20-Chevron 4517 (LDPE):Exxon 3512CB |
| | (LLDPE):Polyfil ABC-5000PB (Talc AB)] |
| V | 6% [85:15-Ticona-Topas 8007 (COC):Chevron 4517 (LDPE)] |
| | 48% [85:15-Dow D118 (HCPP):Chevron 4517 (LDPE)] |
| | 8% [100-Dupont 2174 (Tie)] |
| | 10% [100-Soarnol DC3212B (EVOH)] |
| | 8% [100-Dupont 2174 (Tie)] |
| | 20% [50:30:20-Chevron 4517 (LDPE):Exxon 3512CB |
| | (LLDPE):Polyfil ABC-5000PB (Talc AB)] |
| W | 10% [85:15-Ticona-Topas 8007 (COC):Equistar NA334 |
| | (LDPE)] |
| | 23% [100-Equistar 5885 (HDPE)] |
| | 5% [80:20-Chevron 7109T (LLDPE):Dupont 41E710 |
| | (Tie Conc)] |
| | 10% [100-Soarnol DC3203F (EVOH)] |
| | 5% [80:20-Chevron 7109T (LLDPE):Dupont 41E710 (Tie |
| | Conc)] |
| | 23% [100-Equistar 5885 (HDPE)] |
| | 5% [50:30:20-Chevron 4517 (LDPE):Exxon 3512CB |
| | (LLDPE):Polyfil ABC-5000PB (Talc AB)] |
| | 19% [50:30:20-Chevron 4517 (LDPE):Exxon 3512CB |
| | (LLDPE):Polyfil ABC-5000PB (Talc AB)] |

TABLE 2

| | FILM TYPE | | | | | | | | | | | |
|---|---|---|---|---|---|---|---|---|---|---|---|---|
| | | | | | | | | | Stressed | | GELBO | |
| | BASE | | METALLIZED | | LAMINATED | | FORMER | | FORMER | | 500 | |
| | MVTR | OTR | MVTR | OTR | MVTR | OTR | MVTR | OTR | MVTR | OTR | MVTR | OTR |
| Oriented 1 110 GA | | | | | 0.040 | 0.000 | 0.004 | 0.026 | 0.007 | 0.044 | 0.020 | 0.090 |
| mu842 [Mobil EVOH | | | | | | | | | | | | |
| skin] prior art | | | | | | | | | | | | |
| Oriented 2 70 ga MET | | | | | 0.040 | 1.100 | | | | | 0.040 | 2.360 |
| HB [Mobile HD skin] | | | | | | | | | | | | |
| prior art | | | | | | | | | | | | |
| Oriented 3 70 Metallyte | | | | | 0.028 | 0.678 | 0.012 | 1.602 | 0.007 | 0.976 | NA | NA |
| [Propylene skin] prior art | | | | | | | | | | | | |
| A (Cast) | NA | 0.08 | 0.018 | 0.019 | 0.003 | 0.258 | 0.014 | 0.012 | 0.021 | 0.017 | NA | NA |
| B (cast) | 0.390 | 0.700 | 0.006 | 0.279 | 0.006 | 0.279 | 0.014 | 0.340 | 0.016 | 0.352 | NA | NA |
| C (blown) | 0.308 | 0.106 | 0.008 | 0.054 | 0.001 | 0.068 | | | | | NA | NA |
| D | 0.478 | 0.299 | 0.009 | 0.218 | 0.005 | 0.230 | 0.103 | 0.101 | 0.009 | 0.205 | NA | NA |
| E | 0.496 | 0.275 | 0.009 | 0.225 | 0.003 | 0.249 | 0.008 | 0.380 | 0.015 | 0.332 | NA | NA |
| F | 0.490 | 0.260 | NA | NA | NA | NA | NA | NA | NA | NA | NA | NA |
| G | 0.394 | 0.223 | 0.013 | 0.152 | .008 | .677 | 0.006 | 1.875 | 0.006 | 3.662 | NA | NA |
| H | 0.433 | 0.302 | 0.005 | 0.220 | NA | NA | NA | NA | NA | NA | NA | NA |
| I | 0.357 | 0.244 | 0.333 | 0.340 | NA | NA | NA | NA | NA | NA | NA | NA |
| J | 0.386 | 0.310 | 0.018 | 0.095 | NA | NA | NA | NA | NA | NA | NA | NA |
| K | 0.479 | 169 | 0.003 | 0.531 | NA | NA | NA | NA | NA | NA | NA | NA |
| L | 0.452 | 173 | 0.02 | 0.899 | NA | NA | NA | NA | NA | NA | NA | NA |
| M | 0.437 | 221 | 0.008 | 1.015 | NA | NA | NA | NA | NA | NA | NA | NA |
| N | 0.560 | 232 | 0.075 | 8.124 | NA | NA | NA | NA | NA | NA | NA | NA |
| O | 0.529 | 224 | 0.013 | 3.825 | NA | NA | NA | NA | NA | NA | NA | NA |
| P | 0.476 | 207 | 0.006 | 1.507 | NA | NA | NA | NA | NA | NA | NA | NA |
| Q | 0.496 | 206 | 0.023 | 1.725 | NA | NA | NA | NA | NA | NA | NA | NA |
| R | 0.500 | 311 | NA | NA | NA | NA | NA | NA | NA | NA | NA | NA |
| S | 0.428 | NA | 0.008 | 0.735 | 0.050 | 8.120 | 0.027 | 0.000 | 0.026 | 0.000 | 0.080 | 20.800 |
| T | 0.329 | NA | 0.003 | 0.456 | 0.030 | 0.210 | 0.017 | 0.289 | 0.017 | 0.490 | 0.010 | 1.340 |
| U | 0.408 | NA | 0.034 | 6.095 | 0.030 | 1.870 | 0.010 | 2.782 | 0.011 | 3.406 | 0.011 | 6.530 |
| V | 0.396 | 0.180 | 0.014 | 0.082 | 0.040 | 0.250 | 0.004 | 0.118 | 0.005 | 0.122 | 0.040 | 0.690 |
| W | 0.247 | NA | 0.025 | 0.059 | 0.030 | 0.090 | 0.006 | 0.098 | 0.006 | 0.095 | 0.010 | 0.720 |

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

We claim:

1. A flexible multilayer polymeric film comprising:
a) a flexible base polymer layer;
b) a flexible cyclic olefin copolymer layer which is adhered to the base polymer layer, the flexible cyclic olefin copolymer layer having an exposed surface and comprising a cyclic olefin copolymer; and
c) a vapor deposited layer on an exposed surface of the cyclic olefin copolymer layer, the vapor deposited layer comprising at least one barrier coating.

2. A flexible multilayer polymeric film as in claim 1, wherein said base polymer layer is unoriented.

3. A flexible multilayer polymeric film as in claim 1, further comprising an overcoat layer on the vapor deposited layer such that the vapor deposited layer is between the cyclic olefin copolymer layer and the overcoat layer.

4. A flexible multilayer polymeric film as in claim 1, wherein the cyclic olefin copolymer is an ethylene-norbornene copolymer.

5. A flexible multilayer polymeric film as in claim 1, wherein the cyclic olefin copolymer is present in the cyclic olefin copolymer layer in an amount greater than 40% by weight of the cyclic olefin copolymer layer.

6. A flexible multilayer polymeric film as in claim 1, wherein the cyclic olefin copolymer is present in the cyclic olefin copolymer layer in an amount greater than 60% by weight of the cyclic olefin copolymer layer.

7. A flexible multilayer polymeric film as in claim 1, wherein the cyclic olefin copolymer is present in the cyclic olefin copolymer layer in an amount greater than 80% by weight of the cyclic olefin copolymer layer.

8. A flexible multilayer polymeric film as in claim 1, wherein the cyclic olefin copolymer is present in the cyclic olefin copolymer layer in an amount greater than 90% by weight of the cyclic olefin copolymer layer.

9. A flexible multilayer polymeric film as in claim 1, wherein said flexible cyclic olefin copolymer layer further comprises another polymer different than cyclic olefin copolymer.

10. A flexible multilayer polymeric film as in claim 9, wherein the other polymer is a polyolefin.

11. A flexible multilayer polymeric film as in claim 9, wherein the other polymer is polyethylene.

12. A flexible multilayer polymeric film as in claim 1, wherein the cyclic olefin copolymer has a glass transition temperature range of 70° C. to 140° C.

13. A flexible multilayer polymeric film as in claim 1, wherein the weight ratio of the base polymer layer to the cyclic olefin copolymer layer is from about 5:95 percent to about 95:5 percent.

14. A flexible multilayer polymeric film as in claim 1, wherein the flexible base polymer layer comprises a base polymer selected from the group consisting of polypropylene, polyamide, polyester, polyethylene, co-polymers thereof and blends thereof.

15. A flexible multilayer polymeric film as in claim 1, wherein the barrier coating comprises a metal and/or a ceramic.

16. A flexible multilayer polymeric film as in claim 1, wherein the barrier coating is selected from the group consisting of aluminum, zinc, a composite of nickel on aluminum, a composite of iron on aluminum, a composite of zinc on silver, a composite of zinc on copper, aluminum oxide, iron oxide, silver oxide, and a composite of zinc on aluminum.

17. A flexible multilayer polymeric film as in claim 1, wherein the vapor deposited ceramic is selected from the group consisting of oxides of silicon and carbon coating.

18. A method for producing a flexible multilayer polymeric film comprising vapor depositing a barrier coating on an exposed surface of a flexible cyclic olefin copolymer layer, wherein said flexible cyclic olefin copolymer layer comprises a cyclic olefin copolymer and is adhered to a base polymer layer.

19. A method as in claim 18, wherein said base polymer layer is unoriented.

20. A method as in claim 18, further comprising the step of applying an overcoat layer on the vapor deposited layer such that the vapor deposited layer is between the cyclic olefin copolymer layer and the overcoat layer.

21. A method as in claim 18, wherein the cyclic olefin copolymer is an ethylene-norbornene copolymer.

22. A method as in claim 18, wherein the cyclic olefin copolymer is present in the cyclic olefin copolymer layer in an amount greater than 40% by weight of the cyclic olefin copolymer layer.

23. A method as in claim 18, wherein the cyclic olefin copolymer is present in the cyclic olefin copolymer layer in an amount greater than 60% by weight of the cyclic olefin copolymer layer.

24. A method as in claim 18, wherein the cyclic olefin copolymer is present in the cyclic olefin copolymer layer in an amount greater than 80% by weight of the cyclic olefin copolymer layer.

25. A method as in claim 18, wherein the cyclic olefin copolymer is present in the cyclic olefin copolymer layer in an amount greater than 90% by weight of the cyclic olefin copolymer layer.

26. A method as in claim 18, wherein said flexible cyclic olefin copolymer layer further comprises another polymer different than cyclic olefin copolymer.

27. A method as in claim 26, wherein the other polymer is a polyolefin.

28. A method as in claim 26, wherein the other polymer is polyethylene.

29. A method as in claim 18, wherein the cyclic olefin copolymer has a glass transition temperature range of 70° C. to 140° C.

30. A method as in claim 18, wherein the weight ratio of the base polymer layer to the cyclic olefin copolymer layer is from about 5:95 percent to about 95:5 percent.

31. A method as in claim 18, wherein the flexible base polymer layer comprises a base polymer selected from the group consisting of polypropylene, polyamide, polyester, polyethylene, co-polymers thereof and blends thereof.

32. A method as in claim 18, wherein the barrier coating comprises a metal and/or a ceramic.

33. A method as in claim 18, wherein the barrier coating is selected from the group consisting of aluminum, zinc, a composite of nickel on aluminum, a composite of iron on aluminum, a composite of zinc on silver, a composite of zinc on copper, aluminum oxide, iron oxide, silver oxide, and a composite of zinc on aluminum.

34. A method as in claim 18, wherein the vapor deposited ceramic is selected from the group consisting of oxides of silicon and carbon coating.

35. A flexible container useful for packaging material comprising an enclosure formed of flexible multilayer polymeric film which is folded and sealed together so that the material is storable inside the enclosure, the flexible multilayer polymeric film including:
a) a flexible base polymer layer;
b) a flexible cyclic olefin copolymer layer which is adhered to the base polymer layer, the flexible cyclic olefin copolymer layer having an exposed surface and comprising a cyclic olefin copolymer; and
c) a vapor deposited layer on an exposed surface of the flexible cyclic olefin copolymer layer, the vapor deposited layer comprising at least one barrier coating.

36. A flexible container as in claim 35, wherein the base polymer layer is unoriented.

37. A flexible container as in claim 35, further comprising the step of applying an overcoat layer on the vapor deposited layer such that the vapor deposited layer is between the cyclic olefin copolymer layer and the overcoat layer.

38. A flexible container as in claim 35, wherein the cyclic olefin copolymer is an ethylene-norbornene copolymer.

39. A flexible container as in claim 35, wherein the cyclic olefin copolymer is present in the cyclic olefin copolymer layer in an amount greater than 40% by weight of the cyclic olefin copolymer layer.

40. A flexible container as in claim 35, wherein the cyclic olefin copolymer is present in the cyclic olefin copolymer layer in an amount greater than 60% by weight of the cyclic olefin copolymer layer.

41. A flexible container as in claim 35, wherein the cyclic olefin copolymer is present in the cyclic olefin copolymer layer in an amount greater than 80% by weight of the cyclic olefin copolymer layer.

42. A flexible container as in claim 35, wherein the cyclic olefin copolymer is present in the cyclic olefin copolymer layer in an amount greater than 90% by weight of the cyclic olefin copolymer layer.

43. A flexible container as in claim 35, wherein said flexible cyclic olefin copolymer layer further comprises another polymer different than cyclic olefin copolymer.

44. A flexible container as in claim 43, wherein the other polymer is a polyoelfin.

45. A flexible container as in claim 43, wherein the other polymer is polyethylene.

46. A flexible container as in claim 35, wherein the cyclic olefin copolymer has a glass transition temperature range of 70° C. to 140° C.

47. A flexible container as in claim 35, wherein the weight ratio of the base polymer layer to the cyclic olefin copolymer layer is from about 5:95 percent to about 95:5 percent.

48. A flexible container as in claim 35, wherein the flexible base polymer layer comprises a base polymer selected from the group consisted of polypropylene, polyamide, polyester, polyethylene, co-polymers thereof and blends thereof.

49. A flexible container as in claim 35, wherein the barrier coating comprises a metal and/or a ceramic.

50. A flexible container as in claim 35, wherein the barrier coating is selected from the group consisting of aluminum, zinc, a composite of nickel on aluminum, a composite of iron on aluminum, a composite of zinc on silver, a composite of zinc on copper, aluminum oxide, iron oxide, silver oxide, and a composite of zinc on aluminum.

51. A flexible container as in claim 35, wherein the vapor deposited ceramic is selected from the group consisting of oxides of silicon and carbon coating.

52. A method for packaging material in a form-fill-seal system comprising:
feeding a flexible multilayer polymeric film through the form-fill-seal system;
folding and sealing the multilayer polymeric film in the form-fill-seal system to form a flexible container comprising an enclosure formed of the flexible multilayer polymeric film;
depositing the material in the enclosure; and
sealing the material in the enclosure, wherein the multilayer polymeric film comprises:
a) a flexible base polymer layer;
b) a flexible cyclic olefin copolymer layer which is adhered to the base polymer layer, the flexible cyclic olefin copolymer layer having an exposed surface and comprising a cyclic olefin copolymer; and
c) a vapor deposited layer on an exposed surface of the flexible cyclic olefin copolymer layer, the vapor deposited layer comprising at least one barrier coating.

53. A method as in claim 52, wherein said base polymer layer is unoriented.

54. A method as in claim 52, wherein the multilayer polymeric film further comprises an overcoat layer on the vapor deposited layer such that the vapor deposited layer is between the cyclic olefin copolymer layer and the overcoat layer.

55. A method as in claim 52, wherein the cyclic olefin copolymer is an ethylene-norbornene copolymer.

56. A method as in claim 52, wherein the cyclic olefin copolymer is present in the cyclic olefin copolymer layer in an amount greater than 40% by weight of the cyclic olefin copolymer layer.

57. A method as in claim 52, wherein the cyclic olefin copolymer is present in the cyclic olefin copolymer layer in an amount greater than 60% by weight of the cyclic olefin copolymer layer.

58. A method as in claim 52, wherein the cyclic olefin copolymer is present in the cyclic olefin copolymer layer in an amount greater than 80% by weight of the cyclic olefin copolymer layer.

59. A method as in claim 52, wherein the cyclic olefin copolymer is present in the cyclic olefin copolymer layer in an amount greater than 90% by weight of the cyclic olefin copolymer layer.

60. A method as in claim 52, wherein said flexible cyclic olefin copolymer layer further comprises another polymer different than cyclic olefin copolymer.

61. A method as in claim 60, wherein the other polymer is a polyolefin.

62. A method as in claim 60, wherein the other polymer is polyethylene.

63. A method as in claim 52, wherein the cyclic olefin copolymer has a glass transition temperature range of 70° C. to 140° C.

64. A method as in claim 52, wherein the weight ratio of the base polymer layer to the cyclic olefin copolymer layer is from about 5:95 percent to about 95:5 percent.

65. A method as in claim 52, wherein the flexible base polymer layer comprises a base polymer selected from the group consisting of polypropylene, polyamide, polyester, polyethylene, co-polymers thereof and blends thereof.

66. A method as in claim 52, wherein the barrier coating comprises a metal and/or a ceramic.

67. A method as in claim 52, wherein the barrier coating is selected from the group consisting of aluminum, zinc, a composite of nickel on aluminum, a composite of iron on aluminum, a composite of zinc on silver, a composite of zinc on copper, aluminum oxide, iron oxide, silver oxide, and a composite of zinc on aluminum.

68. A method as in claim 52, wherein the vapor deposited ceramic is selected from the group consisting of oxides of silicon and carbon coating.

69. A packaged material comprising a material stored inside a flexible container, the flexible container comprising an enclosure formed of flexible multilayer polymeric film which is folded and sealed together for receiving the material inside the enclosure, the flexible multilayer polymeric film including:
a) a flexible base polymer layer;
b) a flexible cyclic olefin copolymer layer which is adhered to the base polymer layer, the flexible cyclic olefin copolymer layer having an exposed surface and comprising a cyclic olefin copolymer; and
c) a vapor deposited layer on an exposed surface of the flexible cyclic olefin copolymer layer, the vapor deposited layer comprising at least one barrier coating.
